(19) United States
(12) Patent Application Publication
(10) Pub. No.: US 2025/0148059 A1
(43) Pub. Date: May 8, 2025

(54) METHOD FOR APPLICATION PROTECTION, ELECTRONIC DEVICE, AND COMPUTER-READABLE STORAGE MEDIUM

(71) Applicant: SHENZHEN PAX SMART NEW TECHNOLOGY CO., LTD., Shenzhen, Guangdong (CN)

(72) Inventors: Qiong HUANG, Shenzhen, Guangdong (CN); Aiping ZHOU, Shenzhen, Guangdong (CN); Lingcong ZENG, Shenzhen, Guangdong (CN)

(73) Assignee: SHENZHEN PAX SMART NEW TECHNOLOGY CO., LTD., Shenzhen, Guangdong (CN)

(21) Appl. No.: 18/028,818

(22) PCT Filed: Oct. 13, 2021
(86) PCT No.: PCT/CN2021/123460

§ 371 Date: Jan. 27, 2025

(30) Foreign Application Priority Data
Oct. 14, 2020 (CN) 202011098062.2

(51) Int. Cl. G06F 21/12; G06F 21/57

(52) U.S. Cl. CPC G06F 21/121; G06F 21/577; G06F 2221/033

(57) ABSTRACT

A method for application protection is applicable to the field of computer technologies and includes: detecting an operation state of a target application; terminating the target application to implement protection of the target application in response to detecting that the target application is in a target state. When the application is operated, an operating state of the application is detected in real time, and an operation of the application will be terminated once it is detected that the application is in the target state. A risk in the application may be detected in time, so that the application may be protected in time.

### CROSS-REFERENCE TO RELATED APPLICATIONS

The present application is a 35 U.S.C. § 371 national stage application of PCT patent application No. PCT/CN2021/123460, filed on Oct. 13, 2021, which claims priority to Chinese patent application No. 202011098062.2, filed on Oct. 14, 2020. The entire contents of which are incorporated herein by reference.

### FIELD

The present application relates to the field of computer technologies, and more particularly, to a method for application protection, an electronic device and a computer-readable storage medium.

### BACKGROUND

Program codes of one application (Application, APP) may be cracked by a malicious user and be injected with malicious codes, so that the interest of a user who has installed the application being injected with the malicious codes is damaged.

Thus, application protection is needed in related art.

### SUMMARY

Embodiments of the present application provide a method for application protection, an apparatus for application protection, an electronic device and a computer-readable storage medium, which aim to solve a problem in the related art that applications cannot be better protected.

In the first aspect of the embodiments of the present application, a method for application protection is provided, this method is implemented by a background sever and includes:
detecting an operating state of a target application; and
terminating operation of the target application to protect the target application in response to determining that the target application is in a target state.

Furthermore, the target state includes at least one of following states, including:
a state in which application signature information is inconsistent with preset signature information;
a state in which application dynamic library information is inconsistent with preset dynamic library information;
a state in which the target application is debugged;
a state in which a resource file of the target application is modified; and
a state in which the target application is operated in a software simulation device.

Furthermore, the application dynamic library information is used to indicate the dynamic library file which the target application depends on; the method further includes:
extracting file names of dynamic library files which the target application depends on; and
generating the application dynamic library information according to the file names of the dynamic library files.

Furthermore, generating the preset dynamic library information according to the file names of the various dynamic library files, includes:
combining the file names of the various dynamic library files to obtain a character string according to a preset order;
determining a hash value of the character string as the application dynamic library information.

Furthermore, the method further includes:
determining a locking level of the target application according to risk level information associated with the application installed in the preset application set, and locking the target application according to the determined locking level of the target application, in response to detecting that a system where the target application is installed has installed an application in a preset application set. The application in the preset application set is associated with the risk level information.

Furthermore, the method further includes:
performing a data obfuscation processing on a password entered by the password entry operation to obtain an obfuscated password, in response to detecting a password entry operation and detecting that a preset risk condition is not met currently; or alternatively,
deleting the password entered by the password entry operation and exiting a password entry interface, in response to a detecting the password entry operation and detecting that the preset risk condition is met currently.

Furthermore, the preset risk condition includes at least one of following conditions, which includes:
a condition in which a network disconnection is detected;
a condition in which a screenshot of a current interface is detected;
a condition in which a currently recorded screen is detected;
a condition in which the target application is detected to be in a suspended state.

Furthermore, after obtaining the obfuscated password, the method further includes:
performing a data reverse confusion processing on the obfuscated password to obtain the original password, in response to receiving a password acquisition request entered by a user;
deleting the original password in response to the original password being used.

In one embodiment, an installation package of the target application is obtained by performing following steps:
obtaining a source installation package, and obtaining a target folder containing signature information in the source installation package;
replacing the application signature information in the target folder with the preset signature information, and modify a folder name of the target folder to a preset name;
obtaining the target installation package based on the modified target folder, and determining the target installation package as the installation package of the target application.

In the second aspect, an electronic device is provided in one embodiment of the present application. The electronic device includes a memory, a processor, and a computer program stored in the memory and executable by the processor. The processor is configured to, when executing the computer program, implement the steps of the method for application protection.

In the third aspect, a non-transitory computer-readable storage medium is provided in one embodiment of the present application. The non-transitory computer-readable storage medium stores a computer program. When the computer program is executed by a processor, the processor is configured to implement the method for application protection.

In the fourth aspect, a computer program product is provided in one embodiment of the present application. When the computer program product is executed by the electronic device, the electronic device is caused to perform the method for application protection according to the first aspect.

Compared with the related art, the embodiments of the present application have the following beneficial effects: when one application is operated, the operating state of this application is detected in real time. Once it is detected that this application is in the target state, the operation of the application is terminated, and the risk in the application may be found in time, so that the application is protected in time.

It may be understood that, regarding the beneficial effects of the second aspect, the third aspect, the fourth aspect and the fifth aspect, reference may be made to the relevant descriptions in the first aspect, the beneficial effects of the second aspect, the third aspect, the fourth aspect and the fifth aspect are not repeatedly described herein.

### BRIEF DESCRIPTION OF THE DRAWINGS

In order to describe the technical solutions in the embodiments of the present application more clearly, a brief introduction regarding the accompanying drawings needed to be used for describing the embodiments or the related art is given below. It is obvious that, the accompanying drawings described below are only some embodiments of the present application. A person of ordinary skill in the art may also obtain other drawings according to the current drawings without paying creative efforts.

FIG. 1 illustrates a schematic flow diagram of a method for application protection in accordance with one embodiment of the present application;

FIG. 2 illustrates a schematic flow diagram of the method for application protection in accordance with another embodiment of the present application;

FIG. 3 illustrates a schematic flow diagram of the method for application protection in accordance with yet another embodiment of the present application; and

FIG. 4 illustrates a schematic structural block diagram of an electronic device in accordance with one embodiment of the present application.

### DETAILED DESCRIPTION OF EMBODIMENTS

In the following descriptions, in order to describe but not intended to limit the present application, concrete details including specific system structure and technique are proposed to facilitate a comprehensive understanding of the embodiments of the present application. However, a person of ordinarily skill in the art should understand that, the present application may also be implemented in some other embodiments from which these concrete details are excluded. In other conditions, detailed explanations of method, circuit, device and system well known to the public are omitted, such that unnecessary details which are disadvantageous to understanding of the description of the present application may be avoided.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

It should be further understood that, terms “and/or” used in the description and the annexed claims of the present application are referred to as any combination of one or a plurality of listed item(s) associated with each other and all possible items, and including the combinations thereof.

As is used in the description and the annexed claims, a term “if” may be interpreted as “when” or “once” or “in response to determination” or “in response to detection”. Similarly, terms such as “if it is determined that”, or “if a described condition or event is detected” may be interpreted as “once it is determined” or “in response to the determination” or “once the described condition or event is detected” or “in response to the detection of the described condition or event”.

In addition, in the descriptions of the present application, terms such as “first” and “second”, “third”, etc., are only used for distinguishing purpose in description, but shouldn't be interpreted as indication or implication of a relative importance.

The descriptions of “referring to one embodiment” or “referring to some embodiments”, or the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless otherwise they are specially emphasize in other manner. The terms “comprising”, “including”, “having” and their variations mean “including but is not limited to”, unless otherwise they are specially emphasized in other manner.

In order to describe the technical solutions of the present application, the technical solutions of the present application are described with reference to the following embodiments.

### First Embodiment

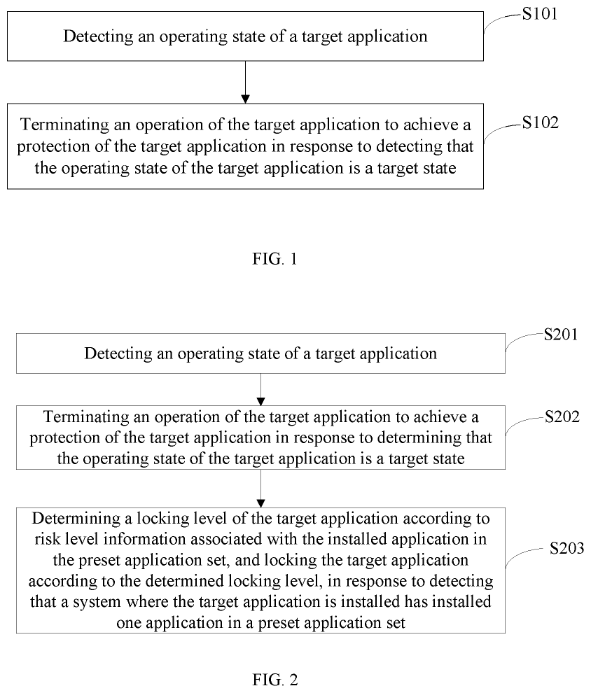

Referring to FIG. 1, a method for application protection is provided in one embodiment of the present application, the method includes:

In a step of S101, an operating state of a target application is detected.

The aforesaid target application is usually a pre-set application.

In this embodiment, an executive subject of the method for application protection may be a server. The server is usually a background server for providing application protection. The server may be implemented as a distributed server cluster composed of multiple servers or be implemented as a single server.

In this embodiment, the server may detect the operating state of the target application through various manners.

As an example, the server may detect the operating state of the target application by querying the value of the preset parameter. For a further example, the server may detect whether the target application is operated on a software simulation device by querying a value of a parameter of TARGET_IPHONE_SIMULATOR. In particular, if the value of the parameter TARGET_IPHONE_SIMULATOR is 1, the target application is in a state of being operated on the software simulation device. If the value of the parameter TARGET_IPHONE_SIMULATOR is 0, the target application is in a state of not being operated on the software simulation device. That is, the target application is in the state of being operated on a hardware device.

As another example, the server may detect the operating state of the target application by comparing whether the current information of the target application is consistent with the corresponding pre-stored information. As a further example, the server may detect whether the target application is in a state in which the application signature information is inconsistent with the preset signature information by comparing whether the application signature information of the target application is consistent with the preset signature information. In particular, if the application signature information is consistent with the preset signature information, the target application is the operating state in which the application signature information is consistent with the preset signature information. If the application signature information is inconsistent with the preset signature information, the target application is in the operating state in which the application signature information is inconsistent with the preset signature information. The application signature information is usually used to perform signature on the target application. In some embodiments, application signature information is usually a character string that is used to identify the application and cannot be falsified by others.

In a step of S102, the target application is terminated, so that the target application is protected, in response to determining that the target application is in a target state.

The aforesaid target state is usually a preset state. For example, the aforesaid target state may be a state in which the application signature information is inconsistent with the preset signature information.

In this embodiment, if the operating state of the target application is determined as the target state, the aforesaid server may terminate the operation of the target application. In some embodiments, the server may control the operation of the target application to be terminated remotely through a network.

According to the method provided in this embodiment, the operating state of the application is detected in real time when the application is operated. Once the operating state of the application is determined to be in the target state, the application will be terminated. The risk of the application may be detected in time, so that the application is protected in time.

In some optional implementations of this embodiment, the aforesaid target state may include, but is not limited to, one or more of the following states:

The first state, that is, the state in which the application signature information is inconsistent with the preset signature information.

Here, for the convenience of illustration, the state in which the application signature information is inconsistent with the preset signature information may be recorded as a first state.

The application signature information is usually used to perform signature on the target application. In some embodiments, application signature information is usually a character string that is used to identify one application and cannot be falsified by others. The aforesaid preset signature information is usually the pre-stored application signature information for the target application.

In some embodiments, each time when the target application is interacted with the background server, the target application needs to send the application signature information thereof to the background server. In this way, the background server may compare whether the received application signature information is consistent with the pre-stored application signature information. If the received application signature information is consistent with the pre-stored application signature information, the target application is considered as being in the state in which the application signature information is consistent with the preset signature information. Otherwise, if the received application signature information is inconsistent with the pre-stored application signature information, the target application is considered as being in the first state currently.

It should be noted that if the target application is currently in the first state, it is generally considered that the target application has been falsified. In this condition, the target application is unsafe.

The second state, that is, the state in which the application dynamic library information is inconsistent with the preset dynamic library information.

The application dynamic library information is used to indicate the dynamic library file that the target application depends on. Herein, for the convenience of illustration, the state in which the application dynamic library information is inconsistent with the preset dynamic library information may be recorded as the second state. The aforesaid dynamic library file is also referred to as dynamic link library (Dynamic Link Library, DLL) file. The dynamic library file is a non-executable binary program file, which allows an application program to share codes and other resources necessary for performing special tasks. The dynamic library file contains many functions and resources. The application program may open, enable, query, disable and close a driver program according to the instructions in the dynamic library file.

In practical application, the application dynamic library information is usually a combination of the file names of the dynamic library files which the application depends on. For example, if the dynamic library files that the application depends on include file A, file B, and file C. Then, the application dynamic library information may be “A-B-C”. The aforesaid preset dynamic library information is usually the pre-stored application dynamic library information for the target application.

In some embodiments, the background server may pre-store the preset dynamic library information. During the operating process of the target application, the name of the dynamic library file that the application depends on may be queried by executing a preset query statement used for querying the dynamic library file that the application depends on. Thus, the application dynamic library information may be calculated based on the file names of the various dynamic library files. Finally, the target application may send the application dynamic library information calculated in real-time to the background server. In this way, the background server may compare whether the received application dynamic library information is consistent with the pre-stored application dynamic library information. If the received application dynamic library information is consistent with the pre-stored application dynamic library information, it is determined that the application dynamic library information of the target application is consistent with the preset dynamic library information. Otherwise, if the received application dynamic library information is inconsistent with the pre-stored application dynamic library information, it is determined that the target application is in the second state currently.

It should be noted that if the target application is in the second state currently, it is generally considered that the target application has been falsified. In this condition, the target application is unsafe.

The third state, that is, the state in which the target application is debugged.

Herein, for the convenience of illustration, a debugged state of the target application may be recorded as a third state.

In some embodiments, when one application is debugged, a debug identifier (e.g., P_TRACED) will be set for an application process. The server may detect whether the application process is being debugged by detecting the presence or the absence of the debug identifier. In particular, if no debug identifier is detected, the target application is not in the state of being debugged currently. Otherwise, if the debug identifier is detected, the target application is considered as being in the third state.

It should be noted that if the target application is currently in the third state, it is generally considered that the target application is being debugged currently. In this condition, the target application is unsafe.

The fourth state, that is, a state in which a resource file of the target application is modified.

Herein, for the convenience of illustration, the state in which the resource file of the target application is modified may be recorded as the fourth state.

The resource file is usually used to provide required resources for one application. The type of the resources may be picture, audio, video, text, or other content that may be displayed on a computer.

In some embodiments, the target application may acquire the resource file thereof by executing a preset statement for acquiring the resource file. Then, a hash value of the resource file is calculated. For example, a MD5 value of the resource file may be calculated. The MD5 value is a widely used cryptographic hash function which may generate a 128-bit hash value to ensure the integrity and the consistency of information transmission. Finally, the background server may obtain the hash value of the calculated resource file and compare the hash value of the calculated resource file with the hash value of the pre-stored resource file. For example, the MD5 value of the calculated resource file is compared with the MD5 value of the pre-stored resource file. If the MD5 value of the calculated resource file is consistent with the MD5 value of the pre-stored resource file, it is considered that the resource file of the target application is unchanged. Otherwise, if the MD5 value of the calculated resource file is inconsistent with the MD5 value of the pre-stored resource file, the target application is considered as being in the fourth state currently.

It should be noted that if the target application is in the fourth state currently, it is generally considered that the target application has been falsified. In this condition, the target application is unsafe.

The fifth state, that is, a state in which the target application is operated on the software simulation device.

Herein, for the convenience of illustration, the state in which the target application is operated on the software simulation device may be recorded as a fifth state.

The aforesaid software simulation device usually refers to a device presented through software simulation.

In some embodiments, the server may check whether the target application is in the state of being operated on the software simulation device by querying the value of the preset parameter (e.g., TARGET_IPHONE_SIMULATOR) used for indicating a device in operation. For example, if the value of the parameter TARGET_IPHONE_SIMULATOR is 0, it is determined that the target application is not operating on the software simulation device, that is, the target application is operated on a hardware device. If the value of the parameter TARGET_IPHONE_SIMULATOR is 1, the target application is in the fifth state currently. In some embodiments, when detecting that the value of the parameter indicates that the target application is in the fifth state, the server will usually continue to perform an operation of opening Bluetooth to further determine whether the target application is in the fifth state. Since the software simulation device do not usually have Bluetooth. Thus, if the Bluetooth may be turned on, the target application may be further determined as being in the fifth state.

It should be noted that, when the target application is operated on the software simulation device, the target application is usually insensitive to some information. For example, capital and small letter of a character string cannot be distinguished, so that the target application is prone to be unsafe.

In this embodiment, it is possible to troubleshoot various situations that may cause one application to be unsafe, so that the security of the application may be further protected.

In the optional implementations of the various embodiments of the present application, if the application dynamic library information is used to indicate the dynamic library file that the target application depends on. In this condition, the application dynamic library information is obtained by performing the following steps:

First, names of the various dynamic library files that the target application depends on are extracted.

In some embodiments, the server may obtain the file names of the dynamic library files that the target application depends on by executing the preset query statement used for querying the dynamic library files that the application depends on.

Then, the application dynamic library information is generated according to the file names of the dynamic library files.

Herein, the server may combine the file names of the various dynamic library files to obtain the application dynamic library information.

Optionally, the server may combine the file names of the various dynamic library files to obtain a character string in a preset order, and then determine the hash value of the character string as the application dynamic library information. Herein, for example, the server may combine the file names of the various dynamic library files by using a symbol “|” as a separator to obtain the character string. For example, if the dynamic library files include the file A, the file B and the file C. Then, the combined character string may be “A|B|C”.

The preset order may be the order of the length of the names or the order of the first letter of the names from A to Z.

In this embodiment, the file names of the dynamic library files are processed to obtain the application dynamic library information, which is low in computational complexity, is prone to be implemented, and facilitates to improve a data processing efficiency.

In some implementations of the various embodiments of the present application, an installation package of the target application may be obtained by performing the following steps:

In the first step, a source installation package is obtained, so that a target folder containing signature information in the source installation package is obtained.

The source installation package usually contains a folder containing signature information. The target folder usually refers to the folder containing signature information.

In this embodiment, the server may obtain the locally stored source installation package directly, and may also obtain the source installation package sent by other device over the network.

In some embodiments, the source installation package is usually an ipa (iPhone Application) package generated through Xcode. The executive body may obtain a bundle folder in the ipa package by uncompressing the ipa package. Herein, the bundle folder is the target folder containing signature information. The Xcode is an integrated development tool. The ipa package is the installation package file for an iOS application. The ipa package may be installed and used by decompressing, and the ipa package can be uninstalled by only deleting the program files.

In the second step, the application signature information in the target folder is replaced with the preset signature information, and the folder name of the target folder is modified as the preset name.

Herein, the preset signature information may be preset information. For example, the preset signature information may be a certificate issued by an Apple enterprise developer, or be called as an enterprise certificate. The enterprise certificate usually includes a series of documents. The preset name may be a name set previously. For example, the preset name may be embedded. mobileprovision.

For example, if the source installation package is the ipa package, the application signature information in the target folder may be replaced with the preset signature information by performing the following operations: deleting the _Code Signature file containing the application signature information in the bundle folder, and replacing a Provisioning Profile in the bundle folder with a Provisioning Profile in the enterprise certificate. The folder name of the target folder may be modified as the preset name by changing the name of the enterprise certificate as embedded. mobileprovision.

In the third step, the target installation package is obtained based on the modified target folder, and the target installation package is determined as the installation package of the target application.

Herein, the server may sign the application with new signature information, and package the signed application with integrated development tool to obtain a new installation package.

In this embodiment, the installation package of the target application is obtained by performing signature on the target application twice, so that the installation package has better security and facilitates in further protecting the security of the target application.

It should be noted that, in order to improve the security of the target application, when the application program of the target application is compiled, the logical part of the application program that involves sensitive information, such as the logic codes related to payment, the codes related to encryption algorithm, etc., is usually compiled in C language which is difficult to be decompiled. Additionally, when this part of codes is compiled in C language, a function name is usually hidden in the structure so as to be stored in the form of pointer. In this way, after the application program is compiled, the address is only visible. However, the function name and parameters in the function are invisible. Since the function name and the parameters in the function cannot be decompiled through the address, the application program may be protected from being decompiled, so that the security of the application program is protected.

It should be noted that, in the code writing process of the application program, data obfuscation may also be performed on other codes which are not compiled in C language, so that it is difficult to decompile the application program, the security of the application program is protected. Additionally, in the code writing process of the application program, some meaningless codes may be added. For example, some spaces may be added, so that it is difficult to decompile the application program, and the security of the application program is further protected.

### Second Embodiment

A method for application protection is provided in this embodiment of the present application. This embodiment is a further description of the first embodiment. Regarding the contents that are the same or similar to the first embodiment, reference can be made to the relevant descriptions in the first embodiment. Referring to FIG. 2, the method for application protection in this embodiment includes:

In a step of S201, an operating state of the target application is detected.

In a step of S202, the target application is terminated, so that the target application is protected, in response to determining that the target application's operating state is a target state.

In this embodiment, the specific operations of the steps S201-S202 are basically the same as that of the steps S101-S102 in the embodiment shown in FIG. 1.

In a step of S203, in response to detecting that the system where the target application is installed has installed an application in a preset application set, a locking level of the target application is determined according to risk level information associated with the application installed in the system is determined, and the target application is determined according to the determined locking level.

The application in the preset application set is associated with risk level information. The aforesaid risk level information is usually used to describe the risk level of the application. As an example, the risk level information may be “1”, and may also be “high” for indicating a high risk of the application. The application in the preset application set is usually a preset application that may damage the function or the authority of the target application.

The system usually refers to an operating system, such as iOS operating system.

In this embodiment, the target application may invoke one application in the preset application set according to the application names of the preset applications in the pre-stored preset application set. When one application is invoked, if the invoking of the application is successful, it is considered that the application has been installed in the system where the target application is installed. Otherwise, if the invoking of the application is unsuccessful, it is considered that the target application is not installed in the system.

In some embodiments, the target application may determine whether the system where the target application is installed has installed one application in the preset application set by opening an URL Scheme of the application in the preset application set. As for one application in the preset application set, if the target application can open the URL Scheme of the application in the preset application set, it is considered that the application is installed in the system where the target application is installed. Otherwise, if the target application cannot open the URL Scheme of the application in the preset application set, it is considered that the application is not installed in the system where the target application is installed. The URL Scheme is a page jumping protocol designed to facilitate a mutual invoking between different applications. The URL Scheme may uniquely identify one application.

In this embodiment, when detecting that the system where the target application is installed has installed one application in the preset application set, the server may determine the locking level of the target application according to the risk level information associated with the application installed in the system.

In some embodiments, the locking level of the target application usually corresponds to the risk level of the application installed in the system. For example, if the application installed in the system is detected as application X, and the risk level information of the application X is “high”, it indicates that the risk level of the application X is high. In this condition, the locking level of the target application may be determined as high.

In this embodiment, when the locking level of the target application is high, all functions of the target application may be locked. In addition, if the locking level of the target application is low, some functions of the target application may be locked.

In this embodiment, when the system where the target application is installed has installed one application in preset application set, a locking manner for the target application may be determined according to the risk level information of the application installed in the preset application set, such that the target application may be protected flexibly and reasonably.

### Third Embodiment

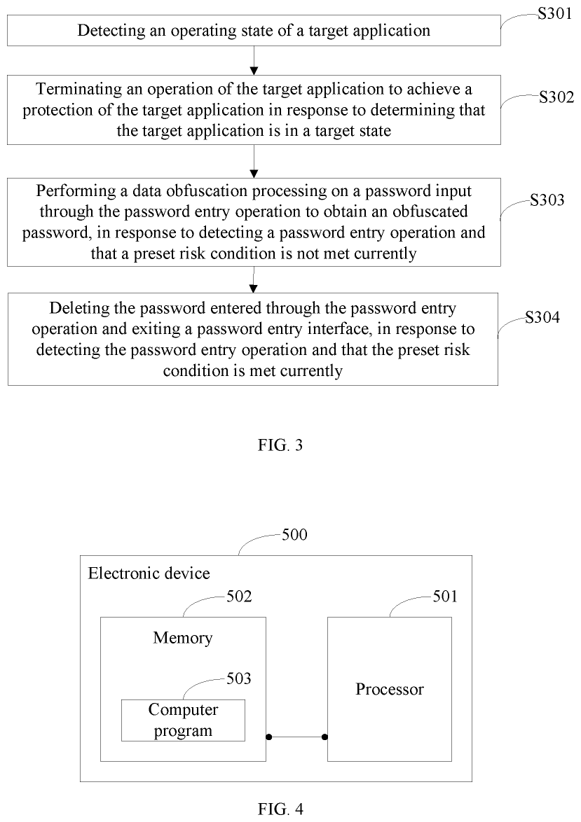

A method for application protection is provided in this embodiment of the present application. This embodiment is a further description of the first embodiment. For the contents that are the same or similar with the first embodiment, reference can be made to the relevant description of the first embodiment. Referring to FIG. 3, the method for application protection in this embodiment includes:

In a step of S301, the operating state of the target application is detected.

In a step of S302, the target application is terminated, so that the target application is protected, in response to determining that the target application is in a target state.

In this embodiment, the specific operations of steps S301-S302 are basically the same as that of the steps S101-S102 in the embodiment shown in FIG. 1.

In a step of S303, data obfuscation is performed on a password entered by the password entry operation to obtain an obfuscated password, in response to detecting a password entry operation and a preset risk condition is not met currently.

In a step of S304, the password entered by the password entry operation is deleted and the password entry interface is exited, in response to detecting the password entry operation and the preset risk condition is met currently.

The password entry operation is usually used for entering a password. As an example, the password entry operation may be the operation of entering a password in the control for entering a password in the password entry interface. As another example, the password entry operation may also be the operation of inputting fingerprint information in the password entry interface. The password entry interface is usually an interface used for receiving the password entered by the user.

The preset risk condition is usually a preset condition used to indicate that it is not suitable to enter a password currently.

In some embodiments, the server may detect a password entry operation by detecting whether information entered through the password entry interface is received.

When the password entry operation is detected, the server may further determine whether the preset risk condition is met. If the preset risk condition is not met, the password entered by the password entry operation will be obtained, and data obfuscation is performed on the entered password to obtain the confused data. If the preset risk condition is met, the password entered in the password entry operation is deleted and the password entry interface is exited. In some embodiments, in order to protect the security of the password, the password entered by the password entry operation is usually deleted by invoking a preset data erasing function. In this way, the password can be quickly deleted. The password is deleted in time, so that the password may be protected from data leakage. The aforesaid preset data erasing function is usually a preset function for clearing data in a memory.

The data obfuscation process usually refers to an operation of rewriting data to generate new data that is unreadable by a user and does not affect the original logic of the data. Data obfuscation process may enable data to be not prone to be leaked, so that data security is ensured. In some embodiments, data obfuscation process usually refers to performing data obfuscation on a data to be obfuscated according to a preset data obfuscation rule. Data obfuscation rule is usually a rule used for performing data obfuscation processing. As an example, the obfuscation processing rule may be a rule that adds a preset value to the data to be obfuscated. As a further example, if the data to be obfuscated is 123, the preset data obfuscation rule indicates that the character corresponding to 1 is 8, the character corresponding to 2 is 4, and the character corresponding to 3 is 0. Then, 840 may be obtained after data obfuscation is performed on the data to be obfuscated.

In this embodiment, whether the preset risk condition is met may be further detected during the password entry process. When the current situation is safe, the password may be obtained and data obfuscation may be performed on the password, so that the security of the password is protected. When the current situation is unsafe, the entered password is deleted in time and the password entry interface is exited directly. The password entered by the user may be properly protected, and the application protection is realized.

In some optional implementations of this embodiment, the preset risk condition includes but is not limited to one or more of the following conditions: a condition in which a network disconnection is detected; a condition in which a screenshot of the current interface is detected; a condition in which it is detected that the screen is recorded currently; a condition in which it is detected that the target application is suspended.

The current interface usually refers to the password entry interface. The target application is suspended usually refers to that the target application is in a suspended state. The suspended state usually refers to a state in which the application process is temporarily transferred from the memory by the operating system. When the target application is in the suspended state, the server may obtain the information used to indicate that the target application is in the suspended state, and thereby determines whether the target application is suspended according to this information.

In this embodiment, if the current situation meets the preset risk condition in the password entry process, it is considered that the current situation is unsafe and it is not suitable for entering the password. In this condition, the target application may clear the entered password and exit the password entry interface. If the password entered is used for payment, the current payment is invalid.

According to this embodiment, the password entered by the user may be properly protected, so that the application protection is realized.

In some optional implementations of this embodiment, after obtaining the obfuscated password, the following steps may also be included: first, in response to a password acquisition request entered by the user, a data reverse confusion processing is performed on the obfuscated password to obtain the original password. Then, in response to the original password being used, the original password is deleted. The data reverse confusion usually refers to an operation of restoring the obfuscated data to the data before obfuscation. For example, after data obfuscation is performed on data 123, an obfuscated data 840 is obtained. In this condition, if data reverse confusion is performed on the obfuscated data 840, the original data 123 may be obtained.

The aforesaid password acquisition request is usually used to obtain the password. In some embodiments, after the password entered by the user is obtained, in order to facilitate a next use of the password, the obfuscated password is usually stored. When the user needs to use the password for the next time, the password acquisition request may be entered. For example, the fingerprint used to confirm the password acquisition request is entered. In this way, after receiving the password acquisition request, the target application may perform data reverse confusion processing on the obfuscated password to obtain the original password. Once the original password is used, the original password is deleted in time to prevent the password from being leaked. In this way, the target application may be further protected.

### Fourth Embodiment

Corresponding to the method for application protection in the embodiments described above, FIG. 4 illustrates a structural diagram of an apparatus 400 for application protection provided in one embodiment of the present application. For the convenience of illustration, the part related to this embodiment of the present application is only illustrated.

### Fourth Embodiment

FIG. 4 illustrates a schematic structural block diagram of an electronic device 500 provided in one embodiment of the present application. As shown in FIG. 4, the terminal device 500 provided by one embodiment of the present application includes: at least one processor 501 (only one processor is shown in FIG. 4), a memory 502 and a computer program 503 stored in the memory 502 and executable by the at least one processor 501. The processor 501 is configured to, when executing the computer program 503, implement the steps of any one of the various method embodiments.

The electronic device 500 may be a computing device such as a server, a desktop computer, a tablet computer, a cloud server, a mobile terminal, etc. The electronic device 500 may include but is not limited to: a processor 501, the memory 502. The person of ordinary skill in the art can understand that, FIG. 4 only illustrates an example of the electronic device 500, but should not be constituted as limitation to the electronic device 500. More or less components than the components shown in FIG. 4 may be included. As an alternative, some components or different components may be combined. For example, the electronic device 500 may also include an input and output device, a network access device, etc.

The so called processor 501 may be central processing unit (Central Processing Unit, CPU), and may also be other general purpose processor, digital signal processor (Digital Signal Processor, DSP), application specific integrated circuit (Application Specific Integrated Circuit, ASIC), field-programmable gate array (Field-Programmable Gate Array, FGPA), or some other programmable logic devices, discrete gate or transistor logic device, discrete hardware component, etc. The general purpose processor may be a microprocessor, as an alternative, the processor can also be any conventional processor, and the like.

The memory 502 may be an internal storage unit of the electronic device 500, such as a hard disk or a memory of the electronic device 500. The memory 502 may also be an external storage device of the electronic device 500, such as a plug-in hard disk, a smart media card (Smart Media Card, SMC), a secure digital (Secure Digital, SD) card, a flash card (Flash Card, FC) equipped on the electronic device 500. Furthermore, the memory 502 may not only include the internal storage unit of the electronic device 500, but also include the external memory of the electronic device 500. The memory 502 is configured to store the computer program, and other procedures and data needed by the electronic device 500. The memory 502 may also be configured to store data that has been output or being ready to be output temporarily.

In the aforesaid embodiments, the descriptions of the embodiments are emphasized respectively, regarding the part of an embodiment which isn't described or disclosed in detail, reference can be made to relevant descriptions in some other embodiments.

When the integrated unit is achieved in the form of software functional units, and is sold or used as an independent product, the integrated unit may be stored in a computer readable storage medium. Based on this understanding, a whole or part of flow process for implementing the method in the embodiments of the present application can also be accomplished in the manner of using computer program to instruct relevant hardware. When the computer program is executed by the processor, the steps in the various method embodiments described above may be implemented. The computer program includes computer program codes which may be in the form of source code, object code, executable documents or some intermediate form, etc. The computer readable medium may include: a USB flash disk, a mobile hard disk, a hard disk, an optical disk, a computer memory, a read-only memory (Read-Only Memory, ROM), a random access memory (Random Access Memory, RAM).

The embodiments described above are only intended to explain but not to limit the technical solutions of the present application. Although the present application has been explained in detail with reference to these embodiments, a person of ordinary skilled in the art that may be aware of the fact that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application, and thus should all be included in the protection scope of the present application.

1. A method for application protection implemented by a server, comprising:
detecting an operating state of a target application; and
terminating operation of the target application to protect the target application in response to determining that the target application is in a target state.

2. The method according to claim 1, wherein the target state comprises at least one of following states of:
a state in which application signature information is inconsistent with preset signature information;
a state in which application dynamic library information is inconsistent with preset dynamic library information;
a state in which the target application is debugged;
a state in which a resource file of the target application is modified; and
a state in which the target application is operated in a software simulation device.

3. The method according to claim 1, wherein the application dynamic library information is used to indicate the dynamic library file which the target application depends on; the method further comprises:
extracting file names of dynamic library files which the target application depends on; and
generating the application dynamic library information according to the file names of the dynamic library files.

4. The method according to claim 1, further comprising:
determining a locking level of the target application according to risk level information associated with the application installed in the preset application set, and locking the target application according to the determined locking level of the target application, in response to detecting that a system where the target application is installed has installed an application in a preset application set; wherein the application in the preset application set is associated with the risk level information.

5. The method according to claim 1, further comprising:
performing a data obfuscation processing on a password entered by the password entry operation to obtain an obfuscated password, in response to detecting a password entry operation and detecting that a preset risk condition is not met currently;
or alternatively, deleting the password entered by the password entry operation and exiting a password entry interface, in response to a detecting the password entry operation and detecting that the preset risk condition is met currently.

6. The method according to claim 5, wherein the preset risk condition comprises at least one of following conditions, including:
a condition in which a network disconnection is detected;
a condition in which a screenshot of a current interface is detected;
a condition in which it is detected that a screen is currently recorded; and
a condition in which it is detected that the target application is in a suspended state.

7. The method according to claim 1, further comprising obtaining an installation package of the target application by:
obtaining a source installation package, and obtaining a target folder containing signature information in the source installation package;
replacing the application signature information in the target folder with the preset signature information, and modifying a folder name of the target folder as a preset name; and
obtaining the target installation package based on the modified target folder, and determining the target installation package as the installation package of the target application.

8. (canceled)

9. An electronic device, comprising a memory, a processor, and a computer program stored in the memory and executable by the processor, wherein the processor is configured to, when executing the computer program, implement steps of a method for application protection, comprising:
detecting an operating state of a target application; and
terminating an operation of the target application to protect the target application, in response to determining that the target application is in a target state.

10. A non-transitory computer-readable storage medium, which stores a computer program, that, when executed by a processor of an electronic device, causes the processor of the electronic device to implement the method according to claim 1.

11. The electronic device according to claim 9, wherein the target state comprises at least one of states, including:
a state in which application signature information is inconsistent with preset signature information;
a state in which application dynamic library information is inconsistent with preset dynamic library information;
a state in which the target application is debugged;
a state in which a resource file of the target application is modified; and
a state in which the target application is operated in a software simulation device.

12. The electronic device according to claim 9, wherein the application dynamic library information is used to indicate the dynamic library file which the target application depends on; when executing the computer program, the processor is further configured to:
extract file names of dynamic library files which the target application depends on; and
generate the application dynamic library information according to the file names of the dynamic library files.

13. The electronic device according to claim 9, wherein when executing the computer program, the processor is further configured to:
determine a locking level of the target application according to risk level information associated with the application installed in the preset application set, and lock the target application according to the determined locking level of the target application, in response to detecting that a system where the target application is installed has installed an application in a preset application set; wherein the application in the preset application set is associated with the risk level information.

14. The electronic device according to claim 9, wherein when executing the computer program, the processor is further configured to:
performing a data obfuscation processing on a password entered by the password entry operation to obtain an obfuscated password, in response to detecting a password entry operation and detecting that a preset risk condition is not met currently; or alternatively,
deleting the password entered by the password entry operation and exiting a password entry interface, in response to a detecting the password entry operation and detecting that the preset risk condition is met currently.

15. The electronic device according to claim 14, wherein the preset risk condition comprises at least one of following conditions, including:
a condition in which a network disconnection is detected;
a condition in which a screenshot of a current interface is detected;
a condition in which it is detected that a screen is currently recorded; and
a condition in which it is detected that the target application is in a suspended state.

16. The electronic device according to claim 14, wherein when executing the computer program, the processor is further configured to:
obtain a source installation package, and obtaining a target folder containing signature information in the source installation package;
replace the application signature information in the target folder with the preset signature information, and modifying a folder name of the target folder as a preset name; and
obtain the target installation package based on the modified target folder, and determining the target installation package as the installation package of the target application.

17. The electronic device according to claim 14, wherein after obtaining the obfuscated password, the processor is further configured to:
perform a data reverse confusion processing on the obfuscated password to obtain the original password, in response to receiving a password acquisition request entered by a user; and
delete the original password in response to the original password being used.

18. The method according to claim 5, wherein after obtaining the obfuscated password, the method further comprises:
performing a data reverse confusion processing on the obfuscated password to obtain the original password, in response to receiving a password acquisition request entered by a user; and
deleting the original password in response to the original password being used.
